(19) United States
(12) Patent Application Publication
(10) Pub. No.: US 2006/0273721 A1
(43) Pub. Date: Dec. 7, 2006

(54) Plasma display panel

(75) Inventors: Eun-Young Jung, Suwon-si (KR); Kyoung-Doo Kang, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/281,408

(22) Filed: Nov. 18, 2005

(30) Foreign Application Priority Data
Nov. 22, 2004 (KR) 10-2004-0095941

(51) Int. Cl. H01J 17/00

(52) U.S. Cl. 313/581

(57) ABSTRACT

A plasma display panel including a first substrate, a second substrate facing the first substrate, a barrier rib arranged between the first and second substrate, an external light absorbing layer arranged between the barrier rib and at least one of the first substrate and the second substrate, and first and second discharge electrodes arranged in the barrier rib and encompassing the discharge cells.

### CROSS-REFERENCE TO RELATED PATENT APPLICATION

This application claims priority to and the benefit of Korean Patent Application No. 10-2004-0095941, filed on Nov. 22, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP structure that improves luminous efficiency and contrast.

2. Discussion of the Background

Generally, PDPs are flat display devices that form an image by exciting a fluorescent material using ultraviolet (UV) rays generated from a gas discharge. PDPs are grabbing much attention as a next generation display device since they may be manufactured having a large, thin screen with high resolution. To increase a PDP's luminous efficiency, the sustain discharge that excites a discharge gas should take place in a large space, the fluorescent layer should have a large surface area, and there should be as few elements as possible that obstruct visible rays emitted from the fluorescent layer.

FIG. 1 is a partial cut-away exploded perspective view of a conventional PDP. Referring to FIG. 1, the PDP includes a first substrate 111 and a second substrate 121 facing each other. Pairs of discharge electrodes 114 are formed on a surface 111a of the first substrate 111 facing the second substrate 121. A first dielectric layer 115 covers the pairs of discharge electrodes 114, and a protective layer 116 covers the first dielectric layer 115. The pairs of discharge electrodes 114 include an X electrode 112 and a Y electrode 113. The X electrode 112 includes a transparent electrode 112b and a bus electrode 112a, and the Y electrode 113 includes a transparent electrode 113b and a bus electrode 113a. Address electrodes 122 are formed on a top surface 121a of the second substrate 121 facing the first substrate 111, and they are arranged in parallel with each other. A second dielectric layer 123 covers the address electrodes 122, barrier ribs 124 are formed on the second dielectric layer 123, and fluorescent layers 125 are formed on side walls of the barrier ribs 124 and on a surface of the second dielectric layer 123 facing the first substrate 111.

However, in the conventional PDP of FIG. 1, sustain discharge occurs at a space between the X and Y electrodes 112 and 113, which are arranged on a bottom surface of the first substrate 111. Thus, the space at which sustain discharge occurs is small, the surface of the fluorescent layers 125 are not very large, and some visible rays emitted from the fluorescent layers 125 are absorbed and/or reflected by the protective layer 116, the first dielectric layer 115, the transparent electrodes 112b and 113b, and the bus electrodes 112a and 113a. Consequently, only about 60% of the visible rays emitted from the fluorescent layers 125 are transmitted through the first substrate 111, thereby significantly lowering luminous efficiency.

### SUMMARY OF THE INVENTION

The present invention provides a PDP with improved luminous efficiency and brightness and increased discharge stability, especially a PDP with improved contrast and that emits less electromagnetic waves.

Additional features of the invention will be set forth in the description which follows, and in part will be apparent from the description, or may be learned by practice of the invention.

The present invention discloses a PDP including a first substrate and a second substrate facing the first substrate, a barrier rib arranged between the first and second substrates and defining discharge cells together with the first and second substrates, an external light absorbing layer arranged between the barrier rib and at least one of the first substrate and the second substrate, first discharge electrodes arranged in the barrier rib and encompassing the discharge cells, and second discharge electrodes arranged in the barrier rib, encompassing the discharge cells, and spaced apart from the first discharge electrodes.

The present invention also discloses a PDP including a first substrate, a second substrate facing the first substrate, a barrier rib arranged between the first and second substrates and defining discharge cells together with the first and second substrates, an external light absorbing layer arranged in grooves formed in at least one of the first substrate and the second substrate, the grooves corresponding to the barrier rib, first discharge electrodes arranged in the barrier rib and encompassing the discharge cells, and second discharge electrodes arranged in the barrier rib, encompassing the discharge cells, and spaced apart from the first discharge is electrodes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a partial cut-away exploded perspective view of a conventional PDP.

FIG. 2 is an exploded perspective view of a PDP according to an exemplary embodiment of the present invention.

FIG. 3 is a schematic perspective view of electrodes in the PDP of FIG. 2.

FIG. 4 is a cross-sectional view of the PDP along line IV-IV of FIG. 2.

FIG. 5 and FIG. 6 are schematic cross-sectional views showing modifications of the PDP of FIG. 4.

FIG. 7 is an exploded perspective view of a PDP according to another exemplary embodiment of the present invention.

FIG. 8 is a cross-sectional view of the PDP along line VIII-VIII of FIG. 7.

### DETAILED DESCRIPTION OF THE ILLUSTRATED EMBODIMENTS

The present invention will now be described more fully with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

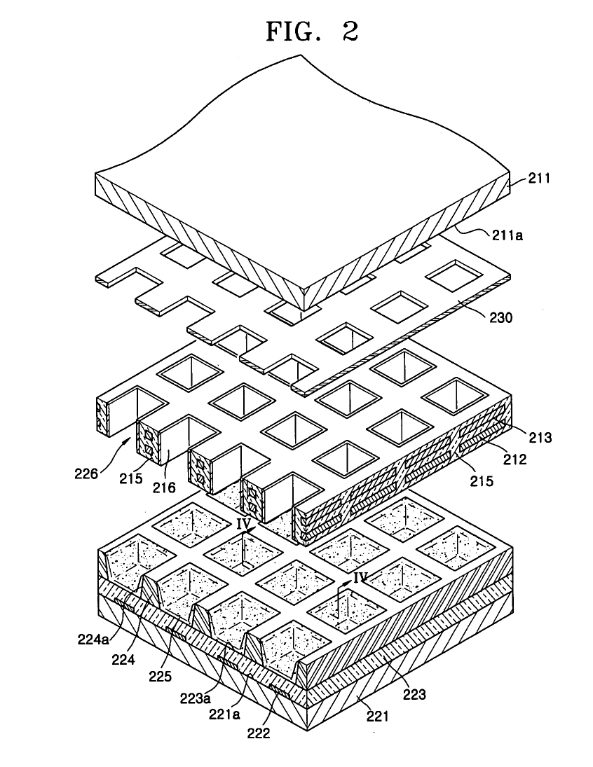

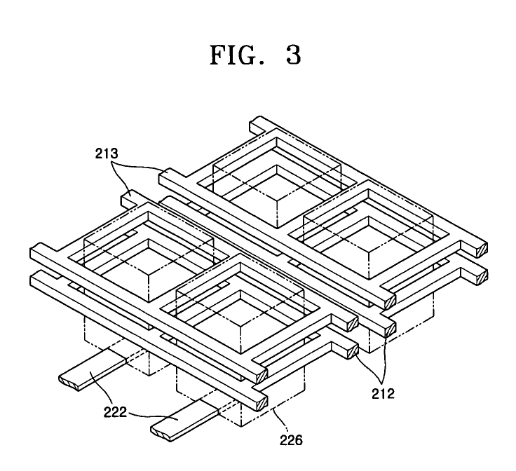

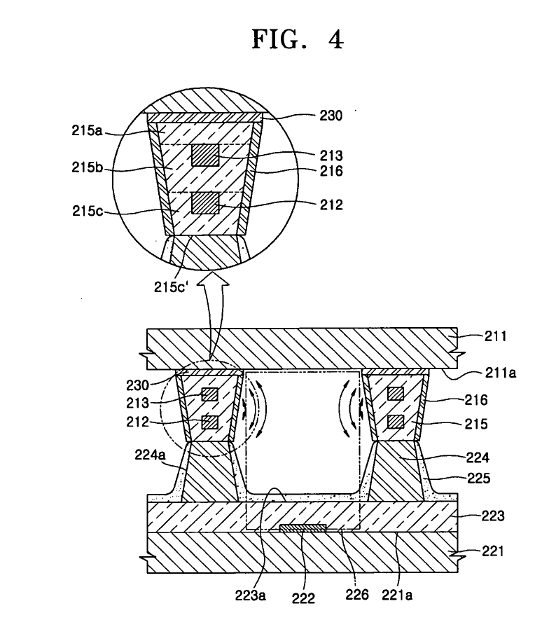

FIG. 2 is an exploded perspective view of a PDP according to an exemplary embodiment of the present invention, FIG. 3 is a schematic perspective view of electrodes in the PDP of FIG. 2, and FIG. 4 is a cross-sectional view of the PDP along line IV-IV of FIG. 2.

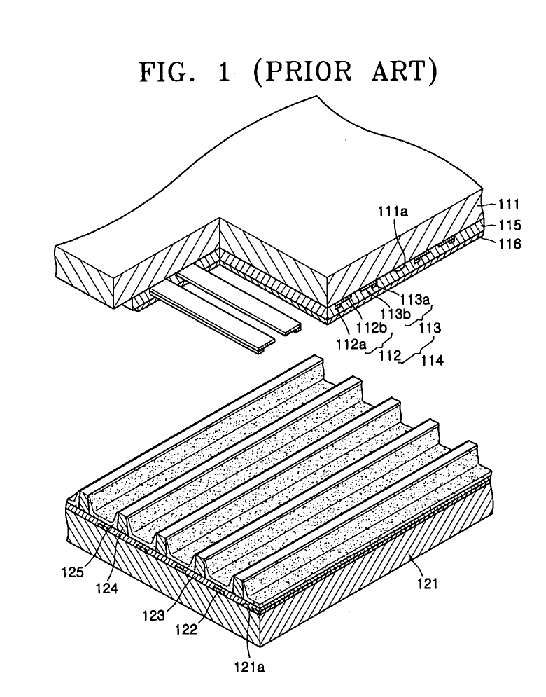

Referring to FIG. 2, FIG. 3, and FIG. 4, a first substrate 211 and a second substrate 221 are arranged facing each other with a predetermined space therebetween. The first and second substrates 211 and 221 may be made of a transparent material such as glass. Unlike the conventional PDP of FIG. 1, a bottom surface 211a of the first substrate 211 does not include discharge electrodes 114 or a dielectric layer 115. Therefore, 80% or more of the visible rays emitted from fluorescent layers 225, described below, may transmit through the first substrate 211, thereby improving luminous efficiency and brightness.

First and second barrier ribs 215 and 224 are arranged between the first and second substrates 211 and 221. Alternatively, the PDP may include either the first barrier rib 215 or the second barrier rib 224. Hereinafter, for the convenience of explanation, a case where the PDP includes the first and second barrier ribs 215 and 224 shown in FIG. 2 will be described. The first barrier rib 215 is arranged closer to the first substrate 211, and the second barrier rib 224 is arranged closer to the second substrate 221. The first and second barrier ribs 215 and 224 define the discharge cells 226 together with the first and second substrates 211 and 221.

Although the discharge cells 226 are shown arranged in a matrix in FIG. 2, they may be arranged in various configurations including a delta shape. Also, although the discharge cells 226 are shown in FIG. 2 with square cross-sections, they may have other shapes including polygonal, such as triangular or pentagonal, circular or oval. This also applies to other embodiments described later.

The first and second barrier ribs 215 and 224, and the first barrier rib 215 in particular, may be made of a dielectric material. Such material prevents direct current flow between first and second discharge electrodes 212 and 213 disposed inside the first barrier rib 215, as well as prevent damage to the first and second discharge electrodes 212 and 213 from collision with charged particles as described below. For example, the dielectric material may be PbO, B₂O₃, and SiO₂.

In this case, a protective layer 216 may cover at least a portion of the side walls of the first and second barrier ribs 215 and 224. FIG. 2 shows the protective layer 216 covering side walls of the first barrier rib 215.

The protective layer 216 may be formed by depositing materials such as MgO. The protective layer 216 may also be formed on a bottom surface 215c′ (see FIG. 4) of the first barrier rib 215 and the bottom surface 211a of the first substrate 211 without too much adverse effect on the PDP of the present embodiment. Forming the protective layer 216 on the bottom surface 211a of the first substrate 211 may enhance secondary electron emission during discharge.

An external light absorbing layer 230 may be arranged between the first substrate 211 and the first and second barrier ribs 215 and 224 and/or between the second substrate 221 and the first and second barrier ribs 215 and 224. FIG. 2 shows the external light absorbing layer 230 arranged between the first substrate 211 and the first and second barrier ribs 215 and 224. However, as noted above, the external light absorbing layer 230 may be formed on at least one of the first and second substrates 211 and 221 through which light generated in the discharge cells 226 is emitted. This applies to all other embodiments described below.

The external light absorbing layer 230, which absorbs external light entering the PDP from outside the PDP, may increase image contrast, as described in detail below. The external light absorbing layer may be made of non-conductive material such as SiO₂, TiO₂, B₂O₃, or Al₂O₃. In this case, materials such as Cu or Mn may be added as a colorant.

Alternatively, the external light absorbing layer 230 may be made with conductive material, such as Ag, to decrease the amount of emitted electromagnetic waves. That is, in the case of the PDP according to the present embodiment, a conductive, mesh-type external light absorbing layer 230 may also prevent emission of electromagnetic waves generated in the PDP to the outside. Rather than the mesh type shown in FIG. 2, the conductive external light absorbing layer 230 may be formed in various configurations including a stripe type, and this applies to all other embodiments described below.

When the conductive external light absorbing layer is formed in other configurations, such as in the stripe type instead of the mesh type, it may be coupled with a common terminal. In this case, equipotential surfaces may be formed on all conductive external light absorbing layers, and thus the electromagnetic waves generated in the PDP may be more effectively prevented from being transmitted to the outside.

Additionally, since the conductive external light absorbing layer has a specific potential, it may affect electrodes to which various voltages are applied to reproduce a predetermined image. Thus, the conductive external light absorbing layer may be coupled with a common terminal that is grounded. Even when the conductive external light absorbing layer 230 is formed in the mesh type, it may be coupled with a grounded common terminal.

The first discharge electrodes 212 are arranged inside the first barrier rib 215, and they encompass the discharge cells 226, which are defined by the first substrate 211, the second substrate 221, and the first and second barrier ribs 215 and 224. Also, the second discharge electrodes 213 are arranged inside the first barrier rib 215, and they encompass the discharge cells 226. The second discharge electrodes 213 are spaced apart from the first discharge electrodes 212. Although FIG. 2 shows the first and second discharge electrodes 212 and 213 inside the first barrier rib 215, they may be arranged in various locations.

To form the first and second discharge electrodes 212 and 213 within the first barrier rib 215, as shown in FIG. 4, a first barrier rib layer 215a is formed on the first substrate 211 including the external light absorbing layer 230, the second discharge electrode 213 is formed on the first barrier rib layer 215a, a second barrier rib layer 215b is formed to cover the second discharge electrode 213, the first discharge electrode 212 is formed on the second barrier rib layer 215b, and a third barrier rib layer 215c is formed to cover the first discharge electrode 212. Each of the first, second, and third barrier rib layers 215a, 215b, and 215c may be stacked in dual layers as desired (e.g., when desiring to increase each layer's thickness). The same method may be used in the case of a single barrier rib or three or more barrier ribs instead of the first and second barrier ribs 215 and 224 shown in FIG. 2.

The first and second discharge electrodes 212 and 213 generate a sustain discharge to form an image on the PDP. The first and second discharge electrodes 212 and 213 may be made of conductive metals such as aluminum or copper.

Referring to FIG. 3, the first and second discharge electrodes 212 and 213 may be formed in the shape of ladders. The first and second discharge electrodes 212 and 213 form a pair and extend in one direction parallel to each other, and the address electrodes 222 are arranged in a direction crossing the first and second discharge electrodes 212 and 213. The first discharge electrodes, second discharge electrodes, and address electrodes 212, 213, and 222 are arranged in this way so that address discharge may occur between the address electrode 222 and one of the first discharge electrode 212 and the second discharge electrode 213, and sustain discharge may then occur between the first discharge electrode 212 and the second discharge electrode 213.

In each discharge cell of the PDP driven by the address discharge and sustain discharge, at least one address electrode made of a conductive metal may be further included besides two discharge electrodes (one pair of discharge electrodes) known as X and Y electrodes. The address discharge occurs between the Y electrode and the address electrode. When the address electrode 222 is arranged below the second discharge electrode 213 and the first discharge electrode 212, as in case of the PDP of the present embodiment, the first discharge electrode 212 may be the Y electrode. When the first discharge electrode 212 is the Y electrode, the second discharge electrode 213 is the X electrode.

Unlike the conventional X and Y discharge electrodes 112 and 113 of FIG. 1, the first and second discharge electrodes 212 and 213 of the PDP of the present embodiment encompass the discharge cells 226. Since sustain discharge occurs along the circumference of the discharge cells 226, the space in which sustain discharge occurs is relatively larger. Thus, the luminous efficiency of the PDP of the present embodiment may be higher than that of the conventional PDP.

Also, the sustain discharge may occur at the top portions of the discharge cells 226 (i.e., portions near the first substrate 211), as shown in FIG. 4. Thus, ion sputtering caused by charged particles during sustain discharge may be reduced. Consequently, a permanent after-image caused by deterioration of the fluorescent layers 225 may be prevented.

Although the address electrodes 222 are arranged in stripes on a top surface 221a of the second substrate 221 in FIG. 2, FIG. 3 and FIG. 4, they may be arranged in other locations and/or configurations. For example, the address electrodes 222 may be arranged to encompass the discharge cells 226. In this case, the address electrodes 222 have a similar shape as the first and second discharge electrodes 212 and 213 (i.e., a ladder shape), and they extend in a direction crossing the first and second discharge electrodes 212 and 213. Additionally, the address electrodes 222 may be arranged between the second discharge electrode 213 and the first substrate 211, between the second discharge electrode 213 and the first discharge electrode 212, or between the first discharge electrode 212 and the second barrier rib 224. The address electrodes 222 may also be arranged on a part of the bottom surface 211a of the first substrate 211. In this case, the address electrodes 222 may be covered by a separate dielectric layer. Wherever the address electrodes 222 are disposed, they are separated and insulated from the first and second discharge electrodes 212 and 213.

A dielectric layer 223 covers the address electrodes 222 to prevent the address electrodes 222 from being damaged by collisions with charged particles during discharge. The dielectric layer 223 may be made of a dielectric material that may induce charged particles. Examples of the dielectric material include PbO, B₂O₃, and SiO₂.

The barrier rib, which defines the discharge cells 226, may include the first and second barrier ribs 215 and 224, as shown in FIG. 2. In this case, the second barrier rib 224 is arranged on the second substrate 221. The second barrier rib 224 defines a space in which fluorescent layers 225 of red, green, and blue emitting materials are arranged. Similar to the first barrier rib 215, the second barrier rib 224 is also shaped in a lattice to partition the space between Xs the first and second substrates 211 and 221 to have rectangular cross sections arranged in a matrix. Therefore, the second barrier rib 224 also defines the discharge cells 226 to have an enclosed cross section. The second barrier rib 224 may also be formed in various shapes as described above.

The fluorescent layers 225 are arranged in the discharge cells 226 on a top surface 223a of the dielectric layer 223 and side walls 224a of the second barrier rib 224, and they may be formed by coating one of the red, green, and blue emitting materials and a fluorescent paste, which a combination of a solvent and a binder, on the top surface 223a of the dielectric layer 223 and the side walls 224a of the second barrier rib 224, and then drying and calcinating one of the fluorescent layers 225. The red emitting fluorescent material may be Y(V, P) O₄:Eu, the green emitting fluorescent material may be Zn₂SiO₄:Mn, or YBO₃:Tb, and the blue emitting fluorescent material may be BAM:Eu.

The fluorescent layers 225 are shown formed on the top surface 223a of the dielectric layer 223 and the side walls 224a of the second barrier rib 224 in FIG. 2 and FIG. 4. However, the fluorescent layers 225 may be arranged in various locations provided they are formed inside the discharge cells 226 since the fluorescent layers 225 emit visible rays by receiving UV rays emitted from a discharge gas, which is described below.

The discharge gas is included in the discharge cells 226. The discharge gas may be, for example, a Ne—Xe gas including 5-15% Xe. When needed, at least a portion of Ne may be substituted with He. Other discharge gasses may be used.

An operation of the PDP constructed as above is briefly described below.

First, applying an address voltage between an address electrode 222 and a first discharge electrode 212 causes an address discharge, thereby selecting the corresponding is discharge cell 226 in which sustain discharge is to occur. Selecting a discharge cell 226 in which sustain discharge is to occur means that wall charges accumulate on a region of the first barrier rib 215 (or the protective layer 216 when the protective layer 216 covers the first barrier rib 215) adjacent to the first and second discharge electrodes 212 and 213 so that sustain discharge may occur. When the address discharge stops, positive ions are accumulated on a region adjacent to the first discharge electrode 212, and electrons are accumulated on a region adjacent to the second discharge electrode 213.

When a sustain discharge voltage is then applied between the first and second discharge electrodes 212 and 213 of the selected discharge cell 226, the positive ions accumulated on the region adjacent to the first discharge electrode 212 and the electrons accumulated on the region adjacent to the second discharge electrode 213 move, thereby causing sustain discharge. As the sustain discharge occurs, the discharge sustain voltage may be alternately applied to the first and second discharge electrodes 212 and 213.

The sustain discharge increases the energy level of the discharge gas, which emits UV rays as its energy level transitions from a high level to a low level. The UV rays increase an energy level of the fluorescent materials in the fluorescent layers 225, which emit visible rays as their energy level transitions from a high level to a low level. Thus, an image may be formed on the PDP by the visible rays emitted as described above from each of the discharge cells 226.

Although the PDP is shown in FIG. 2, FIG. 3, and FIG. 4 including the first discharge electrodes, second discharge electrodes, and address electrodes 212, 213, and 222, it may be constructed differently. For example, the PDP may be driven using the first discharge electrodes 212 and the second discharge electrodes 213, and the address electrodes 222 may be removed. In this case, unlike the arrangement shown in FIG. 3, the second discharge electrodes 213 extend in a first direction, and the first discharge electrodes 212 extend in a second direction to cross the second discharge electrodes 213. The dielectric layer 223 (see FIG. 4) is not needed since there are no address electrodes 222. When the dielectric layer 223 is not included, unlike as shown in FIG. 4, the second barrier rib 224 may be formed on the top surface 221a of the second substrate 221, and the fluorescent layers 225 may be formed on the top surface 221a of the second substrate 221 and the side walls 224a of the second barrier rib 224.

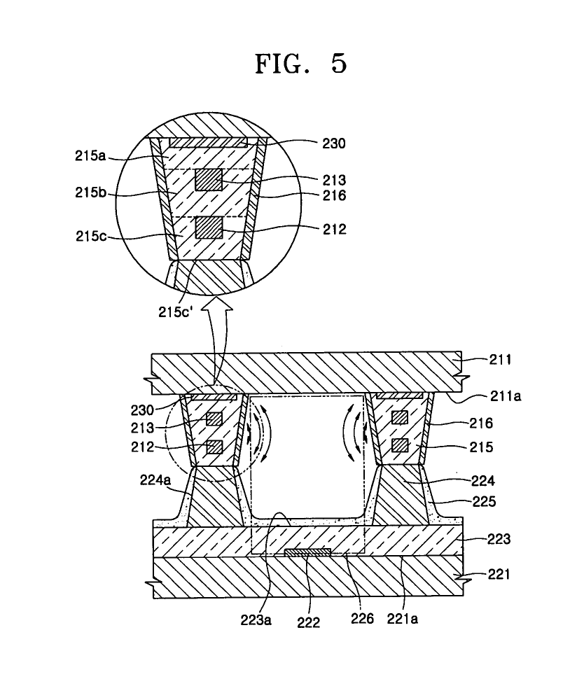

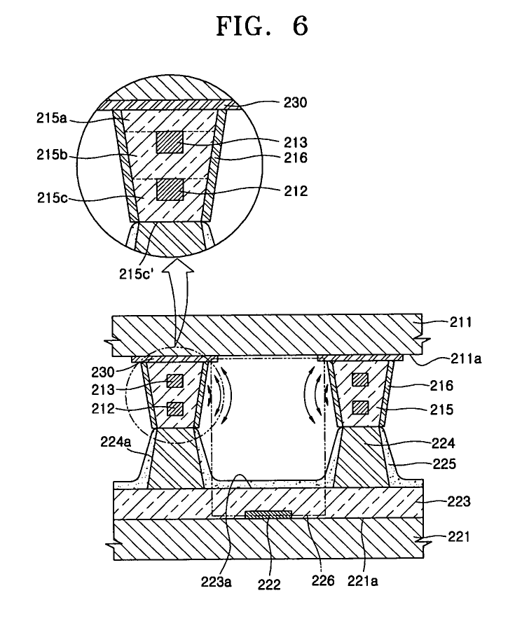

The external light absorbing layer 230 may be formed with different widths. For example, it may be as wide as the first barrier rib 215 as shown in FIG. 4, it may be narrower than the first barrier rib 215 as shown in FIG. 5, or it may be wider than the first barrier rib 215 as shown in FIG. 6.

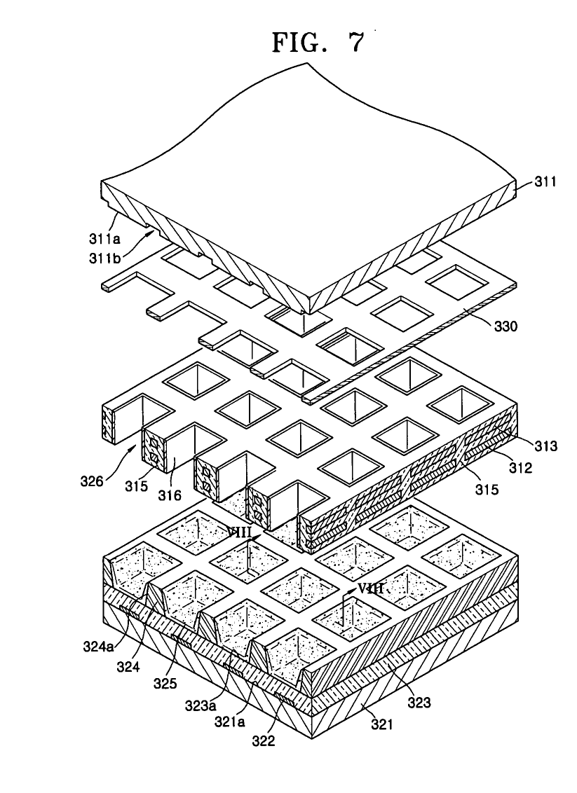

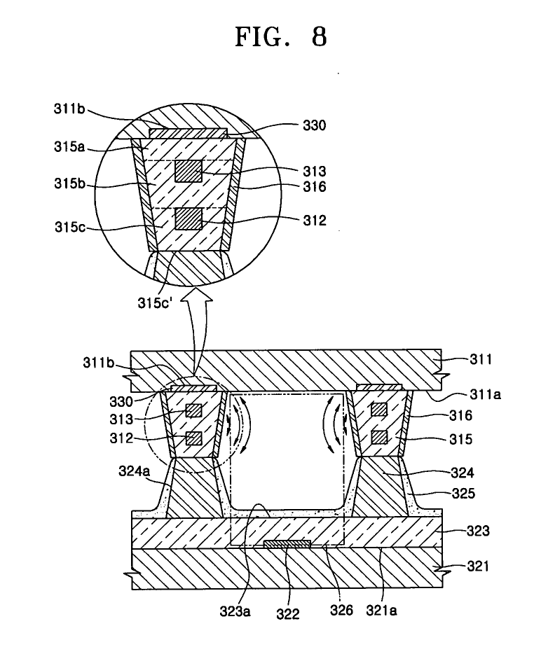

FIG. 7 is an exploded perspective view of a PDP according to another exemplary embodiment of the present invention, and FIG. 8 is a cross-section of the PDP along line VIII-VIII of FIG. 7. Hereinafter, aspects of the PDP of the present embodiment that differ from the PDP of the previous embodiment will be mainly described with reference to FIG. 7 and FIG. 8.

Referring to FIG. 7 and FIG. 8, an external light absorbing layer 330 is arranged between a first barrier rib 315 and a first substrate 311. The PDP of the present embodiment differs from the PDP of the previous embodiment in that grooves 311b are formed in regions of the first substrate 311 corresponding to where the first barrier rib 315 is formed, and the external light absorbing layer 330 is arranged in the grooves 311b. Arranging the external light absorbing layer 330 in the grooves 311b of the first substrate 311 reduces the thickness of the PDP. Consequently, a slimmer PDP may be manufactured.

As described above with reference to FIG. 4, FIG. 5, and FIG. 6, the grooves 311b and the external light absorbing layer 330 may be as wide as, narrower than, or wider than the first barrier rib 315.

Although the PDP shown in FIG. 7 and FIG. 8 emits rays generated in discharge cells 326 to the outside via the first substrate 311, the PDP may be structured to emit the rays to the outside via a second substrate 321. In this case, grooves are formed in the second substrate 321, and an external light absorbing layer is arranged in the grooves in the second substrate 321.

The PDP constructed as above allows manufacturing of a slim PDP with improved contrast.

Additionally, a conductive external light absorbing layer may decrease the amount of emitted electromagnetic waves from the PDP. Here, the external light absorbing layer 330 may be made of a conductive material in a mesh type so that it may decrease the amount of the PDP's emitted electromagnetic waves. The conductive external light absorbing layer 330 may be formed in various shapes including a stripe type, etc., besides the mesh type.

When the conductive external light absorbing layer 330 is formed in other configurations such as the stripe type, etc., and not the mesh type, it may be coupled with a common terminal. Coupling the conductive external light absorbing layers 330 with the common terminal may more effectively prevent electromagnetic wave emission since equipotential surfaces may be formed on all of the conductive external light absorbing layer 330.

Furthermore, since the conductive external light absorbing layer 330 has a specific potential, it may affect electrodes to which various voltages are applied to reproduce predetermined images. Thus, the conductive external light absorbing layer 330 may be coupled with a common terminal that is grounded. The conductive external light absorbing layer 330 may be also connected to the common terminal when it is formed in a mesh type, and the common terminal may be grounded.

Descriptions of the PDP of the present embodiment not mentioned here may be substantially the same as those described in the previous embodiment.

A PDP according to exemplary embodiments of the present invention may obtain the following effects.

Including an external light absorbing layer may improve the PDP's contrast.

A conductive external light absorbing layer, which is made of conductive materials, may decrease an amount of electromagnetic waves emitted by the PDP.

A slim PDP with improved contrast may be manufactured by arranging the external light absorbing layer in a substrate.

Since electrodes do not exist on regions of a first substrate through which generated visible rays are transmitted, aperture rate and transmittance of the visible rays may be significantly improved.

Surface discharge may occur on all side walls defining a discharge cell, thus increasing a discharge surface.

Since discharge may occur at side walls defining discharge cells and diffuse to the center of each discharge cell, the discharge region may be considerably larger than that of a conventional PDP, thereby more efficiently using the space of the discharge cells. As a result, the PDP may operate with low voltage, thereby improving luminous efficiency.

Since the PDP of the present invention and a flat display device including the PDP may be driven by low voltage as described above, the discharge gas may include a high concentration of Xe gas, thereby improving luminous efficiency.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a first substrate;
a second substrate facing the first substrate;
a barrier rib arranged between the first substrate and the second substrate and defining discharge cells together with the first substrate and the second substrate;
an external light absorbing layer arranged between the barrier rib and at least one of the first substrate and the second substrate;
first discharge electrodes arranged in the barrier rib and encompassing the discharge cells; and
second discharge electrodes arranged in the barrier rib, encompassing the discharge cells, and spaced apart from the first discharge electrodes.

2. The PDP of claim 1, wherein the external light absorbing layer comprises a conductive material.

3. The PDP of claim 2, wherein the external light absorbing layer is coupled with a common terminal.

4. The PDP of claim 3, wherein the common terminal is grounded.

5. The PDP of claim 4, further comprising:
a fluorescent layer arranged in the discharge cells; and
a discharge gas in the discharge cells.

6. The PDP of claim 1, wherein the first discharge electrodes extend in a first direction, and the second discharge electrodes extend in a second direction that crosses the first direction.

7. The PDP of claim 1, further comprising:
address electrodes extending in a first direction,
wherein the first discharge electrodes and the second discharge electrodes extend in a second direction that crosses the first direction.

8. The PDP of claim 7, wherein the address electrodes are arranged on the second substrate.

9. The PDP of claim 7, further comprising:
a dielectric layer covering the address electrodes.

10. The PDP of claim 1, further comprising:
a protective layer arranged on at least a portion of side walls of the barrier rib.

11. A plasma display panel (PDP), comprising:
a first substrate;
a second substrate facing the first substrate;
a barrier rib arranged between the first substrate and the second substrate and defining discharge cells together with the first substrate and the second substrate;
an external light absorbing layer arranged in grooves formed in at least one of the first substrate and the second substrate, the grooves corresponding to the barrier rib;
first discharge electrodes arranged in the barrier rib and encompassing the discharge cells; and
second discharge electrodes arranged in the barrier rib, encompassing the discharge cells, and spaced apart from the first discharge electrodes.

12. The PDP of claim 11, wherein the external light absorbing layer comprises a conductive material.

13. The PDP of claim 12, wherein the external light absorbing layer is coupled with a common terminal.

14. The PDP of claim 13, wherein the common terminal is grounded.

15. The PDP of claim 14, further comprising:
a fluorescent layer arranged in the discharge cells; and
a discharge gas in the discharge cells.

16. The PDP of claim 11, wherein the first discharge electrodes extend in a first direction, and the second discharge electrodes extend in a second direction that crosses the first direction.

17. The PDP of claim 11, further comprising:
address electrodes extending in a first direction,
wherein the first discharge electrodes and the second discharge electrodes extend in a second direction that crosses the first direction.

18. The PDP of claim 17, wherein the address electrodes are arranged on the second substrate.

19. The PDP of claim 17, further comprising:
a dielectric layer covering the address electrodes.

20. The PDP of claim 11, further comprising:
a protective layer arranged on at least a portion of side walls of the barrier rib.
